(19) United States
(12) Patent Application Publication
(10) Pub. No.: US 2021/0289721 A1
(43) Pub. Date: Sep. 23, 2021

(54) ERGOSTEROL-RICH AGARICUS BISPORUS AND CULTIVATION METHOD AND USES THEREOF

(71) Applicant: Hanpeng Qu, Changsha (CN)

(72) Inventors: Yun LIANG, Changsha (CN); Sheng CAO, Changsha (CN); Shenjian WANG, Changsha (CN)

(21) Appl. No.: 17/342,776

(22) Filed: Jun. 9, 2021

Related U.S. Application Data
(63) Continuation of application No. PCT/CN2019/101027, filed on Aug. 16, 2019.

(30) Foreign Application Priority Data
Dec. 10, 2018 (CN) 201811506527.6

(51) Int. Cl. A01G 18/20

(52) U.S. Cl. CPC A01G 18/20

(57) ABSTRACT

A method for cultivating ergosterol-rich Agaricus bisporus includes sowing seeds on a culture medium followed by soil covering for mycelium cultivation and sporophore cultivation. During the mycelium cultivation, a light intensity is 100-400 lux and a pH of the culture medium is controlled to 6.0-8.0. During the sporophore cultivation, a light intensity is 20-200 lux and a pH of the culture medium is controlled to 6.0-8.0. The preparation of the culture medium includes the following steps. The manure is mixed with phosphate fertilizer, calcium fertilizer and nitrogen fertilizer to obtain an auxiliary material, and the crop straw and the auxiliary material are subjected to composting and decomposition, pasteurized and adjusted pH to 6.8-7.2 to obtain the culture medium. A healthy food or a functional food containing the ergosterol-rich Agaricus bisporus is also provided herein.

### CROSS-REFERENCE TO RELATED APPLICATIONS

This application is a continuation of International Patent Application No. PCT/CN2019/101027, filed on Aug. 16, 2019, which claims the benefit of priority from Chinese Patent Application No. 201811506527.6, filed on Dec. 10, 2018. The content of the aforementioned applications, including any intervening amendments thereto, is incorporated herein by reference.

### TECHNICAL FIELD

This application relates to production and cultivation of edible fungi, and more particularly to an ergosterol-rich Agaricus bisporus and a cultivation method and uses thereof.

### BACKGROUND

Vitamin D is a fat-soluble steroid derivative necessary for the human body, which can regulate the nutritional function of calcium and phosphorus metabolism and prevent tumor, angiocardiopathy, autoimmune disease and diabetes. Vitamin D₂ and vitamin D₃ are closely related to health. Vitamin D₃ can be obtained by isomerizing 7-dehydrocholesterol in human epidermal cells after exposure to sunlight, while vitamin D₂ cannot be synthesized by the human body. The incidence of childhood rickets, rickets and senile osteoporosis is relatively high in China. Therefore, it is necessary to seek a variety of dietary approaches to supplement the vitamin D₂ levels in human body.

Currently, the main method for obtaining vitamin D₂ in the world is the “ergosterol conversion method”, in which ergosterol is used as a raw material and is converted into vitamin D₂ by a photoconversion method. There are two main preparation methods of ergosterol, one is yeast fermentation method, and the other is waste mycelium method after penicillin fermentation. The mycelium is pretreated, solvent extracted, concentrated and crystallized to obtain the ergosterol, and the ergosterol is converted into vitamin D₂ by the photoconversion method followed by crystallization and separation to obtain the vitamin D₂ product.

However, the above-mentioned methods have low yield and high cost. In addition, when ergosterol is extracted from the mycelium, it will inevitably leads to the residual of solvent and penicillin, making the obtained vitamin D₂ product unsuitable for the production of food.

### SUMMARY

An object of this application is to provide a method for cultivating ergosterol-rich Agaricus bisporus to overcome the problems of food safety hazards and high production costs in extracting ergosterol from mycelium in the prior art, which can effectively increase the ergosterol content of Agaricus bisporus, reduce production costs and ensures the safety of the source of ergosterol.

To achieve the above object, the technical solutions of this application are described as follows.

In a first aspect, this application provides a method for cultivating ergosterol-rich Agaricus bisporus, comprising:

sowing Agaricus bisporus seeds on a culture medium followed by soil covering culture medium; and subjecting the Agaricus bisporus seeds to mycelium cultivation and sporophore cultivation to obtain the ergosterol-rich Agaricus bisporus;

wherein during the mycelium cultivation, a light intensity is 100-400 lux and a pH of the culture medium is 6.0-8.0; and during the sporophore cultivation, a light intensity is 20-200 lux and a pH of the culture medium is controlled to 6.0-8.0.

In some embodiments, during the mycelium cultivation, the light intensity is 200-300 lux and the pH of the culture medium is 6.8-7.2.

In some embodiments, during the sporophore cultivation, the light intensity is 20-100 lux and the pH of the culture medium is 6.5-7.0.

In some embodiments, the mycelium cultivation is performed at a temperature of 20-30° C., a humidity of 60-90% and a CO₂ concentration less than 9000 ppm, and a water content of the culture medium is controlled to 30-70% during the mycelium cultivation; and the sporophore cultivation is performed at a temperature of 13-25° C., a humidity of 60-90% and a CO₂ concentration of 1000-4000 ppm, and a water content of the culture medium is controlled to 35-70% during the sporophore cultivation.

In some embodiments, the mycelium cultivation is performed at a temperature of 23-25° C., a humidity of 85-90% and a CO₂ concentration of 4000-8000 ppm, and the water content of the culture medium is controlled to 60-65% during the mycelium cultivation; and the sporophore cultivation is performed at a temperature of 15-18° C., a humidity of 85-90%, and a CO₂ concentration of 1000-2000 ppm, and the water content of the culture medium is 60-65% during the sporophore cultivation.

In some embodiments, the culture medium is prepared through steps of:

mixing manure with a phosphate fertilizer, a calcium fertilizer and a nitrogen fertilizer to form an auxiliary material; and subjecting the auxiliary material and a crop straw to composting and decomposition followed by pasteurization and pH adjustment to 6.8-7.2 to obtain the culture medium.

In some embodiments, the culture medium consists of:

60-75 parts by weight of the crop straw;

15-25 parts by weight of the manure;

1-5 parts by weight of the phosphate fertilizer;

2-8 parts by weight of the calcium fertilizer; and

1-5 parts by weight of the nitrogen fertilizer.

In some embodiments, the phosphate fertilizer is selected from the group consisting of calcium superphosphate, calcium biphosphate, diammonium phosphate and a combination thereof; the calcium fertilizer is selected from the group consisting of quicklime, slaked lime, gypsum and a combination thereof; and the nitrogen fertilizer is selected from the group consisting of ammonium sulfate, urea, and ammonium bicarbonate and a combination thereof.

In a second aspect, this application provides an ergosterol-rich Agaricus bisporus cultivated by the method mentioned above, wherein an ergosterol content in the ergosterol-rich Agaricus bisporus is not less than 20,000 IU/g.

In a third aspect, this application provides a food comprising the ergosterol-rich Agaricus bisporus, wherein the food is a healthy food or a functional food.

Through the above technical solutions, this application has the following beneficial effects.

This application separately adjusts the pH and light intensity during the mycelium cultivation and the sporophore cultivation, which effectively promotes the synthesis of ergosterol during the growth of the Agaricus bisporus. The concentration of CO₂, the temperature and the humidity are regulated during the mycelium cultivation and the sporophore cultivation to further increase the ergosterol content in ergosterol-rich Agaricus bisporus to obtain plant-derived ergosterol. The ergosterol content in ergosterol-rich Agaricus bisporus obtained by the cultivation method of this application is up to 63,500IU/g.

In order to render the objects, technical solutions and beneficial effects of the disclosure clearer, the disclosure will be described below in detail in conjunction with the following embodiments.

### DETAILED DESCRIPTION OF EMBODIMENTS

The endpoints and any values within the ranges disclosed herein are not limited to the precise range or value, and these ranges or values should be understood to include values close to these ranges or values. For numerical ranges, the end values of each range, the end value and a single point value in each range or individual point values can be combined to give one or more new numerical ranges, and such numerical ranges should be construed as specifically disclosed herein.

In a first aspect, this application provides a method for cultivating ergosterol-rich Agaricus bisporus, in which Agaricus bisporus seeds are sowed on a culture medium followed by soil covering, and the Agaricus bisporus seeds are subjected to mycelium cultivation and sporophore cultivation. During the mycelium cultivation, a light intensity is 100-400 lux and a pH of the culture medium is controlled to 6.0-8.0. During the sporophore cultivation, a light intensity is 20-200 lux and a pH of the culture medium is controlled to 6.0-8.0.

In some embodiments, during the mycelium cultivation, the light intensity is 200-300 lux and the pH of the culture medium is controlled to 6.8-7.2.

In some embodiments, during the sporophore cultivation, the light intensity is 20-100 lux and the pH of the culture medium is controlled to 6.5-7.0.

In some embodiments, the mycelium cultivation is performed at a temperature of 20-30° C., a humidity of 60-90%, a CO₂ concentration less than 9000 ppm, and a water content of the culture medium is controlled to 30-70% during the mycelium cultivation; the sporophore cultivation is performed at a temperature of 13-25° C., a humidity of 60-90%, a CO₂ concentration of 1000-4000 ppm, and a water content of the culture medium is controlled to 35-70% during the sporophore cultivation.

In some embodiments, the mycelium cultivation is performed at the temperature of 23-25° C., the humidity of 85-90%, the CO₂ concentration less than 4000-8000 ppm, and the water content of the culture medium is controlled to 60-65% during the mycelium cultivation; the sporophore cultivation is performed at the temperature of 15-18° C., the humidity of 85-90%, the CO₂ concentration of 1000-2000 ppm, and the water content of the culture medium is controlled to 60-65% during the sporophore cultivation.

In this application, during the mycelium cultivation and the sporophore cultivation, a photo-resistor is used to adjust the current of the lighting circuit of the entire cultivation room, so as to control the brightness of the lighting lamp and adjust the light intensity. The pH of the culture medium is regulated by supplementing the nutrient solution of different pH, especially after harvesting the first and second batch of the Agaricus bisporus.

In some embodiments, the preparation of the culture medium includes mixing manure with a phosphate fertilizer, a calcium fertilizer and a nitrogen fertilizer to form an auxiliary material; and subjecting the auxiliary material and a crop straw to composting and decomposition followed by pasteurization and pH adjustment to 6.8-7.2 to obtain the culture medium.

In this application, the crop straw is selected from the group consisting of wheat straw, corn straw, rice straw and a combination thereof. The manure is selected from the group consisting of cow manure, chicken manure, pig manure and a combination thereof. The phosphate fertilizer can be any phosphorus-containing fertilizer. Preferably, the phosphate fertilizer is selected from the group consisting of calcium superphosphate, calcium biphosphate, diammonium phosphate and a combination thereof. The calcium fertilizer can be any calcium-containing fertilizer. Preferably, the calcium fertilizer is selected from the group consisting of quicklime, slaked lime, gypsum and a combination thereof. The nitrogen fertilizer can be any nitrogen-containing fertilizer. Preferably, the nitrogen fertilizer is selected from the group consisting of ammonium sulfate, urea, and ammonium bicarbonate and a combination thereof.

In some embodiments, the culture medium consists of:

60-75 parts by weight of the crop straw;

15-25 parts by weight of the manure;

1-5 parts by weight of the phosphate fertilizer;

2-8 parts by weight of the calcium fertilizer; and

1-5 parts by weight of the nitrogen fertilizer.

The specific preparation steps are as follows. The manure is mixed with phosphate fertilizer, calcium fertilizer and nitrogen fertilizer to form auxiliary materials. The crop straws are cut into 2-4 cm sections, and soaked in lime water with a concentration of 3-5% for 15-30 h to absorb water to become soft. After picked up and drained, the crop straws are mixed with the auxiliary material and built into a pile. Specifically, a layer of the crop straw with a thickness of 20-30 cm is spread first, on which a layer of the auxiliary material is sprinkled, and the above process is repeated until the pile is built. The pile is turned over every 3-5 days of the fermentation to enable the crop straw and the auxiliary material to be evenly mixed. After the turning is performed 3-5 times, the pile is pasteurized, and then adjusted to pH 6.8-7.2 to obtain the culture medium.

In a second aspect, this application provides an ergosterol-rich Agaricus bisporus cultivated by the method mentioned above.

In a second aspect, this application provides a use of the ergosterol-rich Agaricus bisporus in food, wherein the food is preferably a healthy food or a functional food.

The application will be further described below in detail with reference to the following examples. In the following examples, the ergosterol content in Agaricus bisporus is measured by the method mentioned in GB14755-2010. The calcium superphosphate, calcium biphosphate, diammonium phosphate, quicklime, slaked lime, gypsum, ammonium sulfate, urea, ammonium bicarbonate, wheat straw, corn straw, rice straw, cow manure, chicken manure and pig manure are all commercially available.

### EXAMPLE 1

(1) Preparation of Culture Medium

15 parts by weight of cow manure, 10 parts by weight of chicken manure, 1 part by weight of calcium superphosphate, 5 parts by weight of quicklime and 3 parts by weight of ammonium sulfate were mixed to obtain an auxiliary material. 60 parts by weight of wheat straw and the auxiliary material were subjected to composting and decomposition, pasteurized at 72° C. and adjusted to pH 6.8 to obtain the culture medium.

(2) Sowing and Cultivation

The culture medium obtained in step (1) was transported to a mushroom house, and the seeds were sowed on the culture medium at 1.5 kg/m² and the soils were covered. The mycelium cultivation was performed at a temperature of 23° C., a humidity of 80%, a light intensity of 200 lux and a CO₂ concentration of 4000 ppm for 25 days, where a water content of the culture medium was controlled to 60% and a pH of culture medium was controlled to 6.8. Then the sporophore cultivation was performed at a temperature of 15° C., a humidity of 85%, a light intensity of 20 lux and a CO₂ concentration of 1000 ppm for 6 days, where a water content of the culture medium was controlled to 60% and a pH of the culture medium was controlled to 7.0.

### EXAMPLE 2

(1) Preparation of Culture Mediums

15 parts by weight of cow manure, 5 parts by weight of pig manure, 5 parts by weight of calcium biphosphate, 2 parts by weight of slaked lime and 1 part by weight of urea were mixed to obtain an auxiliary material. 65 parts by weight of corn straw and the auxiliary material were subjected to composting and decomposition, pasteurized at 75° C. and adjusted to pH 7.0 to obtain the culture medium.

(2) Sowing and Cultivation

The culture medium obtained in step (1) was transported to a mushroom house, and the seeds were sowed on the culture medium at 1.5 kg/m² and the soils were covered. The mycelium cultivation was performed at a temperature of 24° C., a humidity of 85%, a light intensity of 250 lux and a CO₂ concentration of 6000 ppm for 25 days, where a water content of the culture medium was controlled to 65% and a pH of the culture medium was controlled to 7.0. Then the sporophore cultivation was performed at a temperature of 18° C., a humidity of 90%, a light intensity of 100 lux, a CO₂ concentration of 1500 ppm for 6 days, where a water content of the culture medium was controlled to 60% and a pH of the culture medium was controlled to6.8.

### EXAMPLE 3

(1) Preparation of Culture Mediums

15 parts by weight of cow manure, 2 parts by weight of diammonium phosphate, 2 parts by weight of calcium superphosphate, 8 parts by weight of gypsum and 5 parts by weight of ammonium bicarbonate were mixed to obtain an auxiliary material. 30 parts by weight of rice straw, 45 parts by weight of wheat straw and the auxiliary materials were subjected to composting and decomposition, pasteurized at 74° C. and adjusted to pH 7.2 to obtain the culture medium.

(2) Sowing and Cultivation

The culture medium obtained in step (1) was transported to a mushroom house, and the seeds were sowed on the culture medium at 1.5 kg/m² and the soils were covered. The mycelium cultivation was performed at a temperature of 25° C., a humidity of 85%, a light intensity of 300 lux and a CO₂ concentration of 8000 ppm for 25 days, where a water content of the culture medium was controlled to 65% and a pH of the culture medium was controlled to 7.2. Then the sporophore cultivation was performed at a temperature of 16° C., a humidity of 90%, a light intensity of 60 lux, a CO₂ concentration of 2000 ppm for 6 days, where a water content of the culture mediums was controlled to 62% and a pH of the culture medium was controlled to 6.5.

### EXAMPLE 4

(1) Preparation of Culture Mediums

10 parts by weight of cow manure, 10 parts by weight of pig manure, 2 parts by weight of calcium superphosphate, 2 parts by weight of slaked lime, 2 parts by weight of gypsum and 3 parts by weight of urea were mixed to obtain an auxiliary material. 70 parts by weight of corn straw and the auxiliary material subjected to composting and decomposition, pasteurized at 72° C. and adjusted to pH 6.8 to obtain the culture medium.

(2) Sowing and Cultivation

The culture medium obtained in step (1) was transported to a mushroom house, and the seeds were sowed on the culture medium at 1.5 kg/m² and the soils were covered. The mycelium cultivation was performed at a temperature of 24° C., a humidity of 80%, a light intensity of 100 lux, a CO₂ concentration of 9000 ppm for 25 days, where a water content of the culture mediums was controlled to 60% and a pH of the culture medium was controlled to 6.0. Then the sporophore cultivation was performed at a temperature of 18° C., a humidity of 90%, a light intensity of 200 lux, a CO₂ concentration of 3000 ppm for 6 days, where a water content of the culture medium was controlled to 60% and a pH of the culture medium was controlled to 6.0.

### EXAMPLE 5

(1) Preparation of Culture Mediums

25 parts by weight of cow manure, 2 parts by weight of calcium superphosphate, 2 parts by weight of gypsum, 1 part of urea and 1 part of ammonium sulfate were mixed to obtain an auxiliary material. The corn straw and the auxiliary material were subjected to composting and decomposition, pasteurized at 75° C. and adjusted to pH 7.0 to obtain the culture medium.

(2) Sowing and Cultivation

The culture medium obtained in step (1) was transported to the mushroom house, and the seeds were sowed on the culture medium at 1.5 kg/m² and the soils were covered. The mycelium cultivation was performed at a temperature of 24° C., a humidity of 85%, a light intensity of 400 lux, a CO₂ concentration of 5500 ppm for 25 days, where a water content of the culture medium was controlled to 65% and a pH of the culture medium was controlled to 8.0. Then the sporophore cultivation was performed at a temperature of 15° C., a humidity of 85%, a light intensity of 150 lux, a CO₂ concentration of 2500 ppm for 6 days, where a water content of the culture medium was controlled to 65% and a pH of the culture medium was controlled to 7.5.

### EXAMPLE 6

(1) Preparation of Culture Mediums

15 parts by weight of cow manure, 10 parts by weight of chicken manure, 1 part of calcium superphosphate, 5 parts by weight of quicklime, and 3 parts by weight of ammonium sulfate were mixed to obtain an auxiliary material. 60 parts by weight of corn straw and the auxiliary material were subjected to composting and decomposition, pasteurized at 72° C. and adjusted to pH 6.8 to obtain the culture medium.

(2) Sowing and Cultivation

The culture medium obtained in step (1) was transported to the mushroom house, and the seeds were sowed on the culture medium at 1.5 kg/m² and the soils were covered. The mycelium cultivation was performed at a temperature of 23° C., a humidity of 80%, a light intensity of 150 lux, a CO₂ concentration of 2000 ppm for 25 days, where a water content of the culture medium was controlled to 50% and a pH of the culture medium was controlled to 7.2. Then the sporophore cultivation was performed at a temperature of 15° C., a humidity of 85%, a light intensity of 150 lux, a CO₂ concentration of 4000 ppm for 6 days, where a water content of the culture medium was controlled to 50% and a pH of the culture medium was controlled to 8.0.

### EXAMPLE 7

(1) Preparation of Culture Mediums

12 parts by weight of cow manure, 12 parts by weight of chicken manure, 2 parts by weight of calcium superphosphate, 6 parts by weight of slaked lime, 2 parts by weight of gypsum, and 3 parts by weight of urea were mixed to obtain an auxiliary material. 30 parts by weight of wheat straw, 30 parts by weight of corn straw and the auxiliary material were subjected to composting and decomposition, pasteurized at 72° C. and adjusted to pH 6.8 to obtain the culture medium.

(2) Sowing and Cultivation

The culture medium obtained in step (1) was transported to the mushroom house, and the seeds were sowed on the culture medium at 1.5 kg/m² and the soils were covered. The mycelium cultivation was performed at a temperature of 20° C., a humidity of 60%, a light intensity of 260 lux, a CO₂ concentration of 6500 ppm for 25 days, where a water content of the culture medium was controlled to 30% and a pH of the culture medium was controlled to 6.8. Then the sporophore cultivation was performed at a temperature of 13° C., a humidity of 65%, a light intensity of 80 lux, a CO₂ concentration of 1000 ppm for 6 days, where a water content of the culture medium was controlled to 35% and a pH of the culture medium was controlled to 7.0.

### EXAMPLE 8

(1) Preparation of Culture Mediums

18 parts by weight of chicken manure, 4 parts by weight of calcium biphosphate, 7 parts by weight of slaked lime and 3 parts by weight of urea were mixed to obtain an auxiliary material. 60 parts by weight of wheat straw and the auxiliary material were subjected to composting and decomposition, pasteurized at 72° C. and adjusted to pH 7.0 to obtain the culture medium.

(2) Sowing and Cultivation

The culture medium obtained in step (1) was transported to a mushroom house, and the seeds were sowed on the culture medium at 1.5 kg/m² and the soils were covered. The mycelium cultivation was performed at a temperature of 30° C., a humidity of 90%, a light intensity of 220 lux, a CO₂ concentration of 7000 ppm for 25 days, where a water content of the culture medium was controlled to 70% and a pH of the culture medium was controlled to 7.0. Then the sporophore cultivation was performed at a temperature of 25° C., a humidity of 90%, a light intensity of 80 lux, a CO₂ concentration of 1500 ppm for 6 days, a water content of the culture medium was controlled to 70% and a pH of the culture medium was controlled to 7.0.

### COMPARATIVE EXAMPLE 1

(1) Preparation of Culture Mediums

15 parts by weight of cow manure, 10 parts by weight of chicken manure, 1 part of calcium superphosphate, 5 parts by weight of quicklime and 3 parts by weight of ammonium sulfate were mixed to obtain an auxiliary material. 60 parts by weight of wheat straw and the auxiliary material were subjected to composting and decomposition, pasteurized at 72° C. and adjusted to pH 7.0 to obtain the culture medium.

(2) Sowing and Cultivation

The culture medium obtained in step (1) was transported to a mushroom house, and the seeds were sowed on the culture medium at 1.5 kg/m²and the soils were covered. The mycelium cultivation was performed at a temperature of 23° C., a humidity of 80%, a light intensity of 500 lux, a CO₂ concentration of 4000 ppm for 25 days, where a water content of the culture medium was controlled to 60% and a pH of the culture medium was controlled to 8.5. Then the sporophore cultivation was performed at a temperature of 15° C., a humidity of 85%, a light intensity of 400 lux, a CO₂ concentration of 1000 ppm for 6 days, a water content of the culture medium was controlled to 60% and a pH of the culture medium was controlled to 8.5.

### COMPARATIVE EXAMPLE 2

(1) Preparation of Culture Mediums

25 parts by weight of cow manure, 2 parts by weight of calcium superphosphate, 2 parts by weight of gypsum, 1 part of urea and 1 part of ammonium sulfate were mixed to obtain an auxiliary material. 65 parts by weight of the corn straw and the auxiliary material were subjected to composting and decomposition, pasteurized at 75° C. and adjusted to pH 7.0 to obtain the culture medium.

(2) Sowing and Cultivation

The culture medium obtained in step (1) was transported to a mushroom house, and the seeds were sowed on the culture medium at 1.5 kg/m² and the soils were covered The mycelium cultivation was performed at a temperature of 30° C., a humidity of 50%, a CO₂ concentration of 10000 ppm for 25 days in dark, where a water content of the culture medium was controlled to 30% and a pH of the culture medium was controlled to 8.0. Then the sporophore cultivation was performed at a temperature of 55° C., a humidity of 60%, a CO₂ concentration of 6000 ppm for 6 days in dark, where a water content of the culture medium was controlled to 30% and a pH of the culture medium was controlled to 8.0.

The ergosterol contents in Agaricus bisporus obtained from Examples 1-8 and Comparative Examples 1-2 were determined, and the results were shown in Table 1.

TABLE 1
Ergosterol contents in Agaricus bisporus

| Number | Ergosterol content (IU/g) |
|---|---|
| Example 1 | 60800 |
| Example 2 | 62300 |
| Example 3 | 63500 |
| Example 4 | 57890 |
| Example 5 | 45670 |
| Example 6 | 33270 |
| Example 7 | 21245 |
| Example 8 | 20190 |
| Comparative Example 1 | 15890 |
| Comparative Example 2 | 17400 |

It can be seen from the results in Table 1 that the ergosterol content in the Agaricus bisporus obtained from Examples 1-8 was significantly increased. It can be seen from the comparison between Example 1 and Comparative Example 1 that by adjusting the light intensity and the pH of the culture medium, the ergosterol content can be increased by 282%. The ergosterol content in the Agaricus bisporus can reach 63500 IU/g through the cultivation method of this application.

The above are only the preferred embodiments of the present disclosure, and are not intended to limit the scope of the present disclosure. Any changes, modifications and improvements made by those skilled in the art without departing from the spirit of the present disclosure shall fall within the scope of the present disclosure defined by the appended claims.

What is claimed is:

1. A method for cultivating ergosterol-rich Agaricus bisporus, comprising:
sowing Agaricus bisporus seeds on a culture medium followed by soil covering culture medium; and subjecting the Agaricus bisporus seeds to mycelium cultivation and sporophore cultivation to obtain the ergosterol-rich Agaricus bisporus;
wherein during the mycelium cultivation, a light intensity is 100-400 lux and a pH of the culture medium is controlled to 6.0-8.0; and during the sporophore cultivation, a light intensity is 20-200 lux and a pH of the culture medium is controlled to 6.0-8.0.

2. The method of claim 1, wherein during the mycelium cultivation, the light intensity is 200-300 lux and the pH of the culture medium is controlled to 6.8-7.2.

3. The method of claim 1, wherein during the sporophore cultivation, the light intensity is 20-100 lux and the pH of the culture medium is controlled to 6.5-7.0.

4. The method of claim 1, wherein the mycelium cultivation is performed at a temperature of 20-30° C., a humidity of 60-90% and a CO₂ concentration less than 9000 ppm, and a water content of the culture medium during the mycelium cultivation is controlled to 30-70%; and the sporophore cultivation is performed at a temperature of 13-25° C., a humidity of 60-90% and a CO₂ concentration of 1000-4000 ppm, and a water content of the culture medium is controlled to 35-70% during the sporophore cultivation.

5. The method of claim 4, wherein the mycelium cultivation is performed at a temperature of 23-25° C., a humidity of 85-90% and a CO₂ concentration of 4000-8000 ppm, and the water content of the culture medium is controlled to 60-65% during the mycelium cultivation; and the sporophore cultivation is performed at a temperature of 15-18° C., a humidity of 85-90% and a CO₂ concentration of 1000-2000 ppm, and the water content of the culture medium is controlled to 60-65% during the sporophore cultivation.

6. The method of claim 1, wherein the culture medium is prepared through steps of:
mixing manure with a phosphate fertilizer, a calcium fertilizer and a nitrogen fertilizer to form an auxiliary material; and subjecting the auxiliary material and a crop straw to composting and decomposition followed by pasteurization and pH adjustment to 6.8-7.2 to obtain the culture medium.

7. The method of claim 6, wherein the culture medium consists of:
60-75 parts by weight of the crop straw;
15-25 parts by weight of the manure;
1-5 parts by weight of the phosphate fertilizer;
2-8 parts by weight of the calcium fertilizer; and
1-5 parts by weight of the nitrogen fertilizer.

8. The method of claim 6, wherein the phosphate fertilizer is selected from the group consisting of calcium superphosphate, calcium biphosphate, diammonium phosphate and a combination thereof; the calcium fertilizer is selected from the group consisting of quicklime, slaked lime, gypsum and a combination thereof; and the nitrogen fertilizer is selected from the group consisting of ammonium sulfate, urea, and ammonium bicarbonate and a combination thereof.

9. The method of claim 7, wherein the phosphate fertilizer is selected from the group consisting of calcium superphosphate, calcium biphosphate, diammonium phosphate and a combination thereof; the calcium fertilizer is selected from the group consisting of quicklime, slaked lime, gypsum and a combination thereof; and the nitrogen fertilizer is selected from the group consisting of ammonium sulfate, urea, and ammonium bicarbonate and a combination thereof.

10. An ergosterol-rich Agaricus bisporus cultivated by the method of claim 1, wherein an ergosterol content in the ergosterol-rich Agaricus bisporus is not less than 20,000 IU/g.

11. A food comprising the ergosterol-rich Agaricus bisporus of claim 10, wherein the food is a healthy food or a functional food.
